(19) United States
(12) Patent Application Publication
(10) Pub. No.: US 2025/0075808 A1
(43) Pub. Date: Mar. 6, 2025

(54) CONTROL VALVE

(71) Applicant: KOGANEI CORPORATION, Koganei-shi, Tokyo (JP)

(72) Inventor: Ryoji KANAI, Tokyo (JP)

(21) Appl. No.: 18/705,850

(22) PCT Filed: Oct. 7, 2022
(86) PCT No.: PCT/JP2022/037673

§ 371 Date: Oct. 31, 2024

(30) Foreign Application Priority Data
Nov. 2, 2021 (JP) 2021-179695

(51) Int. Cl. F16K 7/12; F16K 27/02

(52) U.S. Cl. CPC F16K 7/12; F16K 27/0236

(57) ABSTRACT

The disclosure includes a main body block 11 forming a primary-side flow path to which a fluid is supplied and a secondary-side flow path to which the fluid is discharged; a square cylinder 12 which is attached to the main body block 11 and assembles a valve drive mechanism and whose end surface is a rectangular cross-section; a valve member arranged between the main body block 11 and the cylinder 12; a fastening member 62 fastening the main body block 11 and the cylinder 12 by sandwiching a first flange provided in the main body block 11 and a second flange provided in the cylinder 12; and a fixing pin 74 communicating with a communication hole 72, which is formed in the fastening member 62, and press-fitted into the communication hole 72 and an attachment hole 71 formed at a corner portion of the cylinder 12.

### CROSS-REFERENCE TO RELATED APPLICATIONS

This application is a National Stage application of International Patent Application No. PCT/JP2022/037673, filed on Oct. 7, 2022, which claims priority to Japanese Patent Application No. 2021-179695, filed Nov. 2, 2021, which is hereby incorporated by reference in its entirety.

### TECHNICAL FIELD

The present invention relates to a control valve including a main body block in which a primary side flow path and a secondary side flow path are formed, and a cylinder provided with a valve drive mechanism.

### BACKGROUND

In a fluid supply device that supplies a fluid from a fluid pressure source to a fluid pressure device or the like, a control valve is used for opening/closing flow paths and controlling pressures. As the control valve used for such applications, there is a flow path block in which a primary-side flow path and a secondary-side flow path are provided, that is, a main body block, and a drive block that is attached to the main body block, that is, a cylinder. A primary-side pipe connected to the fluid pressure source is connected to the primary-side flow path, and a secondary-side pipe for supplying the fluid to the fluid pressure device or the like is connected to the secondary-side flow path. Between the main body block and the cylinder, a valve member for opening/closing a communication portion between the primary-side flow path and the secondary-side flow path or for changing an opening degree is provided, and the valve member is driven by a valve drive mechanism provided in the cylinder.

As for a flow rate control valve described in Patent Document 1, the cylinder is typically attached to the main body block by a screw member and a plate located at a lower end of the main body block. Meanwhile, a control valve described in Patent Document 2 has a fastening block located at a bottom surface of the flow path block, and the driving block is attached to the flow path block by a pin attached to the fastening block.
Patent Document 1: Japanese Patent Application Laid-open No. 2003-322275
Patent Document 2: Japanese Patent Application Laid-open No. 2014-31842

### SUMMARY

In the flow rate control valve described in Patent Document 1, if it is assumed that an outer shape of the cylinder in which a cylinder hole is formed with a circular cross-section is defined as a quadrilateral cross-section, a space is formed between the cylinder hole and an outer surface of the cylinder at four corners of the cylinder. When the screw member is attached in this space and in a longitudinal direction of the cylinder and a tip of the screw member is screwed to the plate provided at the lower end of the main body block, the cylinder and the main body block can be fastened by the screw member. In this way, when the cylinder is attached to the main body block by the screw member and the plate, a head portion of the screw member has a diameter larger than that of the screw member, and a space of the head portion of the screw member needs to be secured between the cylinder hole and the outer surface of the cylinder. Further, a plate or a nut needs to be provided at the lower end of a cylinder body. Therefore, in the control valve in the form of fastening the cylinder and the main body block by the screw member, downsizing of the cylinder is limited.

In the control valve described in Patent Document 2, a drive block is attached to the flow path block without using a screw member. However, in a form, in which a fastening member is arranged on a bottom surface of the flow path block and the drive block and the flow path block are fixed by a pin attached to the fastening member, it is difficult to make the form a manifold type in which a plurality of drive blocks are attached to a single flow path block.

When each of the drive block and the flow path block is made of a resin and they are fastened by the screw member, a stress is applied to the entire portion, which receives a fastening force by the screw member, in the drive block and the flow path block. When the stress is applied, the resin member generates a creep phenomenon that distortion increases with lapse of time. Therefore, when the fastening force is applied to the resin drive block and the resin flow path block by the screw member, the strain increases over the entire portion of a thickness, to which the fastening force is applied, and the fastening force by the screw member is weakened and a leakage of the fluid may occur.

An object of the present invention is to achieve downsizing of a control valve.

A control valve of the present invention includes: a main body block forming a primary-side flow path to which a fluid is supplied and a secondary-side flow path discharging the fluid; a cylinder attached to the main body block, and incorporating a valve drive mechanism; a communication portion communicating the primary-side flow path and the secondary-side flow path; a valve member arranged between the main body block and the cylinder, and changing a communication opening degree of the communication portion by the valve drive mechanism; a fastening member sandwiching a first flange provided in the main body block and a second flange provided in the cylinder, and fastening the main body block and the cylinder; and a fixing pin communicating with a communication hole formed in the fastening member and press-fitted into an attachment hole, which is formed in the cylinder, and the communication hole.

A control valve of the invention includes: a main body block forming a primary-side flow path to which a fluid is supplied and a secondary-side flow path discharging the fluid; a cylinder attached to the main body block, and incorporating a valve drive mechanism; a communication portion communicating the primary-side flow path and the secondary-side flow path; a valve member arranged between the main body block and the cylinder, and changing a communication opening degree of the communication portion by the valve drive mechanism, and; a fastening member sandwiching a first flange provided in the main body block and a second flange provided in the cylinder, and fastening the main body block and the cylinder, the fastening member having a plurality of fastening adapters combined with each other by engagement between an engagement claw and an engagement portion with which the engagement claw is engaged.

The first flange provided in the main body block and the second flange provided in the cylinder are abutted against each other, the cylinder is attached to the main body block, and the fastening member is attached to the flange by sandwiching both the abutted flanges. When the fixing pin is press-fitted into the attachment hole formed at the corner portion of the cylinder, the fastening member is fixed to the flange portion by the press-fitted fixing pin. The main body block and the cylinder are fastened by the fastening member. As compared with the case where the main body block and the cylinder are fastened by the screw member provided at the corner portion of the cylinder, when the fixing pin having no head portion is attached to the corner portion of the cylinder, the space of the corner portion can be narrowed and the control valve can be miniaturized.

When the fastening members are formed by the plurality of fastening adapters that are engaged with each other, by combining the fastening adapters the fastening member is attached to the flange by sandwiching both flanges. When the fastening member is engaged and assembled, assembly is facilitated while reducing the size of the control valve.

### BRIEF DESCRIPTION OF THE DRAWINGS

FIG. 1 is a perspective view showing an appearance of a control valve that is one embodiment;

FIG. 2 is an enlarged front view of a control valve;

FIG. 3 is a right side view of FIG. 2;

FIG. 4 is an enlarged cross-sectional view taken along the line A-A in FIG. 3;

FIG. 5 is an enlarged cross-sectional view of a main portion in FIG. 4;

FIG. 6 is an exploded perspective view of a valve drive mechanism incorporated in a cylinder;

FIG. 7 is a perspective view showing an upper end portion of the cylinder and a pin press-fitted into an attachment hole of the upper end portion;

FIG. 8 is an exploded perspective view showing the cylinder and a main body block, and a fastening member for fastening them;

FIG. 9 is a front view showing a main body block in a manifold type control valve;

FIG. 10 is a front view of a control valve that is another embodiment;

FIG. 11(A) is a perspective view showing an upper end portion of the cylinder of FIG. 10, and FIG. 10(B) is a cross-sectional view taken along the line B-B in FIG. 10;

FIG. 12 is an exploded view of the control valve shown in FIG. 10; and

FIG. 13 is a front view of a control valve that is yet another embodiment.

### DETAILED DESCRIPTION

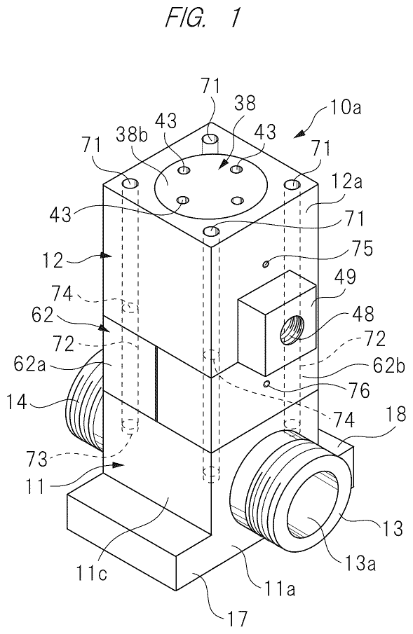

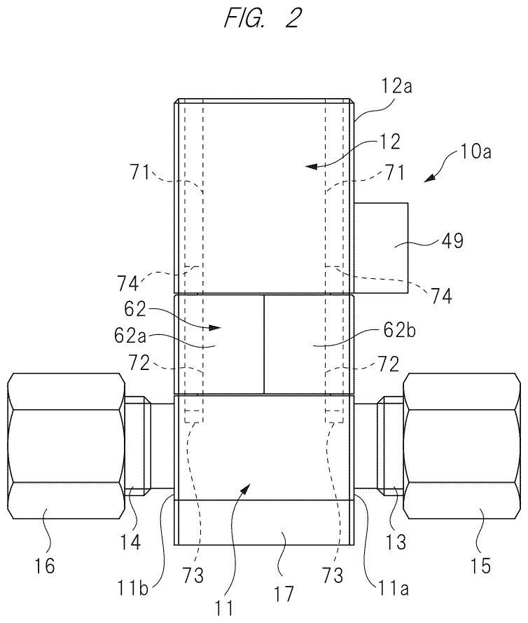

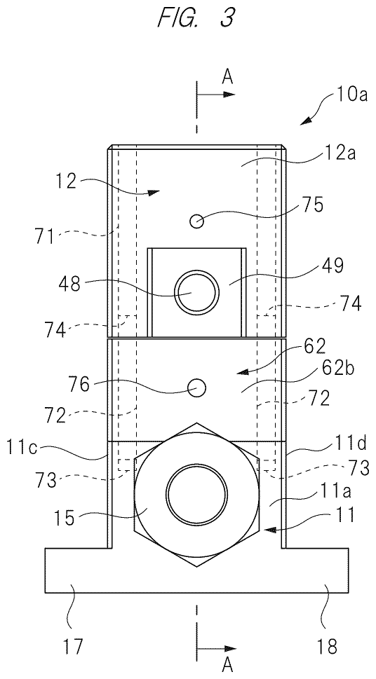

Hereinafter, embodiments of the present invention will be described in detail based on the drawings. As shown in FIGS. 1 to 4, a control valve 10a includes a main body block 11 and a cylinder 12. End surfaces of the main body block 11 and the cylinder 12 are square in a plan view, and an outer peripheral surface is configured by four flat surfaces. The main body block 11 is made of a PFA (4 fluoride ethylene resin), and the cylinder 12 is made of PPS (polyphenylene sulfide). A primary-side joint portion 13 is provided so as to protrude from a front surface 11a of the main body block 11, and a secondary-side joint portion 14 is provided so as to protrudes from a back surface 11b. Both joint portions 13, 14 become coaxial. In FIGS. 2 to 4, nuts 15, 16 for fastening a hose or the like are shown in the respective joint portions 13, 14 in a screwed state, and the nuts 15, 16 are omitted in FIG. 1. Leg portions 17, 18 are provided so as to protrude from the lower end portions of side surfaces 11c, 11d of the main body block 11. A material of the main body block 11 may be a fluororesin such as PTFE (polytetrafluoroethylene), another resin, or metal. Further, a material of the cylinder 12 may be a resin or metal other than PPS.

The control valve 10a can be arranged on a base (not shown) by regarding the leg portions 17, 18 as lower sides. However, the control valve 10a may be in a form in which the leg portions 17, 18 are not provided. In the specification, an up-down relationship of the control valve 10a is shown on the basis of a state in which the leg portions 17, 18 are arranged by regarding them as the lower sides.

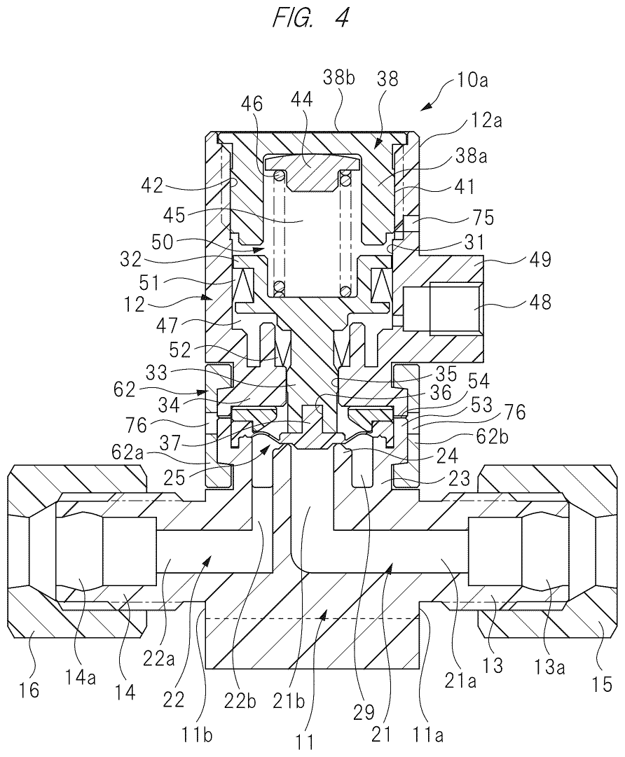

As shown in FIG. 4, the primary-side flow path 21 is formed in the main body block 11, and the primary-side flow path 21 has a main flow path 21a extending in a right-left direction in FIG. 4 of the main body block 11. The main flow path 21a communicates with a primary-side port 13a provided in the joint portion 13, and the primary-side pipe connected to a liquid supply source such as a pump is connected to the primary-side port 13a. The secondary-side flow path 22 is formed in the main body block 11, and the secondary-side flow path 22 has a main flow path 22 extending in the right-left direction in FIG. 4 of the main body block 11. The main flow passage 22a communicates with a secondary-side port 14a provided in the joint portion 14, and the secondary-ide pipe connected to a liquid discharge tool is connected to the secondary-side port 14a.

The main flow path 21a communicates with a surface of a coupling portion 23 of the main body block 11 by a communication flow path 21b, and the communication flow path 21b extends in a direction perpendicular to the main flow path 21a. The main flow path 22a communicates with the surface of the coupling portion 23 of the main body block 11 by a communication flow path 22b, and a communication flow path 22b extends in the direction perpendicular to the main flow path 22a and becomes parallel to the communication flow path 21b.

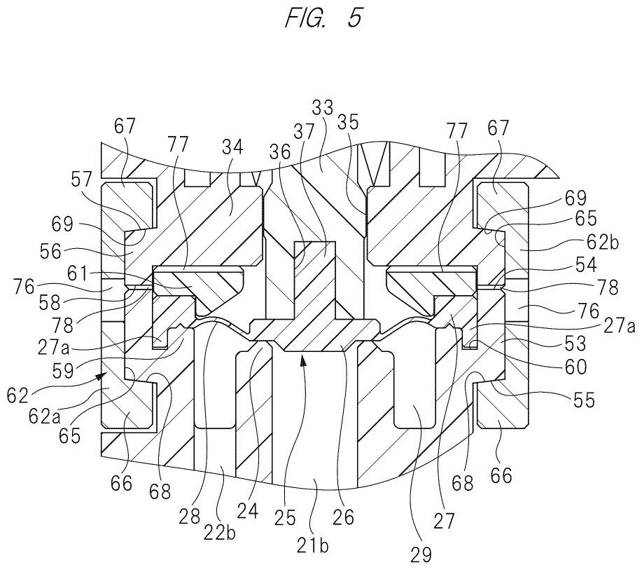

As shown in FIG. 5, the valve member 25 is a diaphragm valve, and has a valve body 26 for opening/closing a valve seat portion 24 serving as a communication portion, an annular portion 27 arranged in the coupling portion 23, and an elastic deformation portion 28 between the valve body 26 and the annular portion 27, and is formed of a fluororesin. The valve seat 24 provided at the couple portion 23, and the communication chamber 29 formed between the valve member 25 and the main body block 11 configures a communication portion communicating with the primary-side flow path 21 and the secondary-side flow path 22, and the communication path flow 21b in the primary-side flow path 21 is opened on a surface of the coupling portion 23 in the main block body 23. The valve member 25 is arranged on the surface of the coupling portion 23 in the main body block 11.

As shown in FIG. 4, the cylinder hole 31 is formed in the cylinder 12, and the cylinder hole 31 has a circular cross-sectional shape. The piston 32 is incorporated into the cylinder hole 31 so as to be reciprocable in a linear direction. A piston rod 33 provided in the piston 32 penetrates through a through-hole 35 provided in the coupling portion 34 at the lower end portion of the cylinder 12 and protrudes toward the main body block 11. An attachment hole 36 is provided at a projection end portion of the piston rod 33, a projection portion 37 of the valve element 26 is inserted into the attachment hole 36, and the valve element 26 is attached to the piston rod 33.

A lid member 38 is attached to an opening end portion of the cylinder hole 31. The lid member 38 has a cylindrical portion 38a and an end plate portion 38b provided at an end portion of the cylindrical portion 38a, a male screw 41 is formed in the cylindrical portion 38a, and the male screw 41 is screwed to a female screw 42 formed at the opening end portion of the cylinder hole 31. As shown in FIG. 1, the engagement hole 43 is formed on an outer surface of the end plate portion 38b of the lid member 38 and by engaging a jig (not shown) with the engagement hole 43 and rotating the lid member 38, the lid member 38 can be screwed to the female screw 42 and be removed from the cylinder 12.

A spring chamber 45 is formed between the spring reception member 44, which is arranged on an inner surface of the end plate portion 38b, and the inner surface of the piston 32, and a spring member 46 configured by a compression coil spring is arranged in the spring chamber 45. The spring member 46 applies a spring force in a direction toward the valve seat portion 24, that is, a direction in which the flow path is closed, to the valve element 26 via the piston 32. When the spring member 46 is abutted against the spring reception member 44 to screw the lid member 38 to the cylinder 12, the spring reception member 44 slips on the inner surface of the end plate portion 38b to prevent the spring member 46 from twisting.

A fluid chamber 47 is formed between the piston 32 and the coupling portion 34 of the cylinder 12, an operation port 48 communicating with the fluid chamber 47 is provided in an operation portion 49, and the operation portion 49 is provided on the front surface 12a of the cylinder 12. An air supply flow path (not shown) is connected to the operation port 48, and compressed air supplied from a compressed air supply source is supplied to the fluid chamber 47. When compressed air is supplied to the fluid chamber 47, the valve element 26 is driven in a direction away from the valve seat against the spring force of the spring member 46, moves to a first position separated from the valve seat portion 24 and is in an open state, that is, a communication state between the primary-side flow path 21 and the secondary-side flow path 22. When the compressed air in the fluid chamber 47 is discharged outside, the valve element 26 moves to a second position closer to the valve seat portion 24 than the first position by the spring force of the spring member 46, and is in a closed state or a blocked state between the primary-side flow path 21 and the secondary-side flow path 22. In this way, a communication opening degree of the communication portion is changed by separating or approaching the valve element 26, which configures the valve member 25, away from or to the valve seat portion 24.

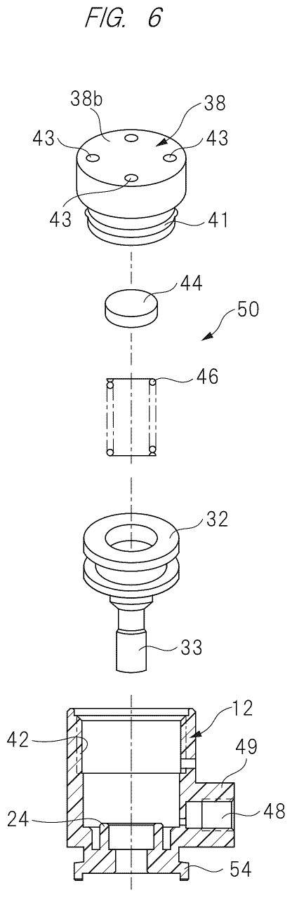

As shown in FIG. 4, the seal member 51 is attached to the piston 32 and seals a region between the spring chamber 45 and the fluid chamber 47. Further, the seal member 52 is attached between the piston rod 33 and the cylinder 12, and seals the fluid chamber 47. The piston 32, the spring member 46, and the like configure a valve drive mechanism 50 for opening/closing the valve member 25, and an actuator for driving the valve member 25 is configured by the cylinder 12 and the valve drive mechanism 50 incorporated therein. The valve member 25 moves up and down by the valve drive mechanism 50 to change the communication opening degree of the communication portion. FIG. 6 shows a state in which the piston 32, the spring member 46, and the like configuring the valve drive mechanism 50, and the cylinder 12 for accommodating them are decomposed.

The flange 53 is provided in the coupling portion 23 of the main body block 11, and the flange 53 is a first flange. If it is assumed that a linear reciprocation direction of the piston rod 33 is defined as a longitudinal direction, as shown in FIG. 5, the flange 53 extends in the longitudinal direction, and an abutting surface 54 on an upper surface and a fastening surface 55 on a lower surface are provided on both end surfaces. The fastening surface 55 is an inclined surface inclined upward from a radial inside toward a radial outside. The flange 56 is provided on the coupling portion 34 of the cylinder 12 so as to oppose the flange 53, and the flange 56 is a second flange. The flange 56 extends in the longitudinal direction, and a fastening surface 57 on an upper surface and an abutting surface 58 on a lower surface are provided on both end surfaces. The fastening surface 57 is an inclined surface inclined downward from a radial inside toward a radial outside. When the cylinder 12 is assembled to the main body block 11, the abutting surface 58 of the flange 56 abuts against the abutting surface 54 of the flange 53.

The projection portion 59 is provided radially inwardly the flange 53, a recess portion 60 is formed between the projection portion 59 and the flange 53, and an outer peripheral fixing portion 27a of the annular portion 27 of the valve member 25 enters into the recess portion 60. A fastening ring 61 is arranged inside the flange 56, and the annular portion 27 of the valve member 25 is sandwiched between the projection portion 59 and the fastening ring 61.

The control valve 10a has a fastening member 62 that fastens the main body block 11 and the cylinder 12, and the fastening member 62 configured by a first fastening adapter 62a and a second fastening adapter 62b. The fastening adapters 62a, 62b are made of metal or a resin. As shown in FIG. 8, each of the fastening adapters 62a, 62b has a long piece portion 64a and a short piece portion 64b in a right-angle direction from both end portions thereof, and its outer surface is a flat surface, and its inner surface has a circular arc surface shape. On the inner surfaces of the fastening adapters 62a, 62b, concave surfaces 65 that are abutted against the outer peripheral surfaces of the flanges 53, 56 are formed. A first pressing portion 66 and a second pressing portion 67, which are continuous with the recess surface 65, are provided on both sides of the respective fastening adapters 62a, 62b. The pressing portion 66 has a fastening surface 68 for pressing the fastening surface 55 of the flange 53, and the pressing portion 67 has a fastening surface 69 for pressing the fastening surface 57 of the flange 56, and the respective fastening surfaces 68, 69 are formed on the inner surfaces of the fastening adapters 62a, 62b. The respective fastening surfaces 68, 69 are the inclined surfaces corresponding to the fastening surfaces 55, 57. The fastening member 62 is configured by at least two fastening adapters.

As shown in FIG. 1, attachment holes 71 are formed at four corner portions of the cylinder 12, whose end surface is square in a plan view, so as to extend in the longitudinal direction, and the respective attachment holes 71 penetrate thought the cylinder 12. Communication holes 72 are formed in the fastening adapters 62a, 62b correspondingly to the attachment hole 71 and, further, a communication hole 73 is formed in the main body block 11. A longitudinal center portion of the fixing pin 74 is press-fitted into the communication hole 72, a lower end portion of the fixing pin 74 is press-fitted into the communication hole 73, and an upper end portion of the fixing pin 74 is press-fitted into the attachment hole 71. The fixing pin 74 is attached to the cylinder 12 by using four corner portions and a space between the cylinder hole 31 and the outer surface of the cylinder 12, so that a size of the cylinder 12 can be reduced while securing the inner diameter of the cylinder hole 31.

When the screw is used to fasten the cylinder 12 and the main body block 11, a head having a larger diameter than that of a portion of a screw body needs to be arranged between the cylinder hole 31 and the outer surface of the cylinder. In a case of performing screw coupling, since it is necessary to have a screw diameter size that maintains sufficient strength for the coupling, making the screw small is limited. In addition, in order to perform the coupling by the screw, a combination with the female screw is needed, and in order to provide the female screw to a member(s) made of a resin, the screw diameter of the female screw needs to be increased for maintaining sufficient strength of the female screw. When the female screw is provided on metal such as a nut or a plate, it is necessary to fix the main body block 11 and the cylinder 12 so as to sandwich them between the nut or the plate.

In contrast, when the cylinder 12 and the main body block 11 are fastened by the fixing pin 74 without using the screw member, the fixing pin 74 may only press the fastening adapters 62a, 62b so that they are not separated from the control valve 10a, and can be fixed by use of the fixing pin 74 having a smaller diameter than use of the screw. Therefore, dimension between the cylinder hole 31 and the outer surface of the cylinder 12 can be reduced, and the cylinder 12 can be miniaturized. At least two communication holes 72 may be formed in the fastening adapters 62a, 62b.

As shown in FIGS. 1 and 8, the fastening adapter 62a has two communication holes 72 adjacent to each other along the same outer surface as that of the control valve 10a, and the fastening adapter 62b has two other communication holes 72 adjacent to each other to each other along the same outer surface on an opposite side to the fastening adapter 62a. Although the fastening member 62 is separated into the two fastening adapters 62a, 62b, the two fastening adapters 62a, 62b may be made of a resin and can be freely opened/closed by a hinge member(s).

As shown in FIG. 1, an outer shape of the cylinder 12 is a quadrangle in a plan view, but instead of this, the cylinder 12 leads to having five corners if the outer shape of the cylinder 12 is pentagonal in a plan view. In this case, the cylinder 12 and the main body block 11 can be fastened by five fixing pins 74. In this way, an end surface shape or a transverse section shape of the cylinder 12 configuring the control valve 10a is not limited to a quadrangle, and can be a rectangular shape composed of another polygon such as a triangle. The polygonal shape also includes a shape in which all or a part of corners are round-chamfered or chamfered. In addition, the outer shape of the cylinder 12 in the plan view may have a combined shape of a straight line and a curve such as a circle or a D-cut without being limited to a square shape.

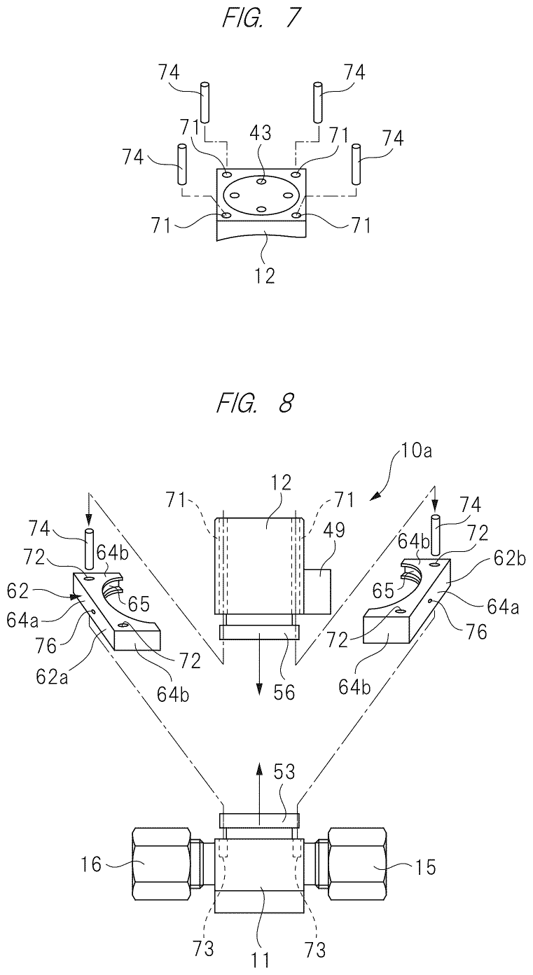

FIG. 7 is a perspective view showing an upper end portion of the cylinder 12, and each fixing pin 74 is press-fitted from an upper end opening portion of the attachment hole 71 formed in the cylinder 12. The respective fastening adapters 62a, 62b sandwich the flanges 53, 56, a fastening surface 68 of a pressing portion 66 is pressed against the fastening surface 55 of the flange 53, and a press-fitting operation of the fixing pin 74 is performed under a state in which the fastening surface 69 of the pressing portion 67 is pressed against the fastening surface 57 of the flange 56.

The fixing pins 74 penetrate through the communication holes 72 of the fastening adapters 62a, 62b, the upper end portion is supported by the attachment hole 71, and the lower end portion is supported by the communication hole 73. Any one of the upper end portion or the lower end portion of the fixing pin 74 may be supported. When the lower end portion of the fixing pin 74 is supported by the communication hole 72, the communication hole 73 may not be provided in the main body block 11. When the upper end portion of the fixing pin 74 is supported by the attachment hole 71 and the lower end portion is supported by the communication hole 73, the fastening adapters 62a, 62b can be reliably held as compared with a case where only one of the upper end portion and the lower end portion is supported. At this time, when the fastening adapters 62a, 62b are made of a transparent resin or a translucent resin, presence or absence of the fixing pin 74 can be determined by visual observation and image recognition, and erroneous assembly can be prevented.

The fastening adapters 62a, 62b fixed by the fixing pin 74 are pressed so as to surround the entire outer peripheral surfaces of the flanges 53, 56. Even if the main body block 11 and the cylinder 12 are made of a fluororesin having a large deformation due to a creep phenomenon, the flanges 53, 56 are wrapped and covered by the fastening adapters 62a, 62b, so that even if the creep phenomenon occurs, a sheet force for holding the valve member 25 is held over a long period of time. Further, the annular portion 27 of the valve member 25 receives the fastening force from the flanges 53, 56, but since a thickness of an outer peripheral fixing portion 27a is thin, there is little decrease in an elastic force due to the creep phenomenon due to chronological changes and temperature changes. Consequently, durability of the control valve 10a can be improved without causing the deformation of the valve member 25 even if the main body block 11 and the cylinder 12 are made of a fluororesin having the large deformation due to the creep phenomenon.

As shown in FIG. 4, a breath hole 75 communicating with the spring chamber 45 is provided in the cylinder 12, and when the piston 32 reciprocates, an inflow of outside air into the spring chamber 45 and an exhaust of internal air from the spring chamber 45 are performed by the breath hole 75. Further, the breath hole 76 is formed in the fastening adapters 62a, 62b, and the breath holes 76 communicate with a space formed between the valve member 25 and the coupling portion 34 of the cylinder 12. In order to communicate the space and the breath hole 76, a plurality of breath grooves 77 are radially formed in the fastening ring 61, and a breath groove 78 is also formed between the abutment surface 54 of the flange 53 and the abutment surface 58 of the flange 56.

To assemble the control valve 10a, as shown in FIG. 6, a member(s) configuring the valve drive mechanism 50 is incorporated into the cylinder 12. The cylinder 12 in which the valve drive mechanism 50 is incorporated is conveyed to the main body block 11 as shown by an arrow in FIG. 8, and the flange 53 of the main body block 11 and the flange 56 of the cylinder 12 are abutted against each other. Under this state, the two fastening adapters 62a, 62b sandwich the flanges 53, 56, and are attached to the flanges 53, 56. The communication holes 72 are made to coincide with the attachment hole 71 and the communication hole 73 by pressing the fastening adapters 62a, 62b to the flanges 53, 56 so as to approach each other. Consequently, a fastening force in a direction of approaching each other is applied to the two flanges 53, 56. Under this state, the fixing pin 74 is press-fitted from the attachment hole 71, and the fastening member 62 is fastened to the main body block 11 and the cylinder 12 by the fixing pin 74. Consequently, the control valve 10 an is assembled.

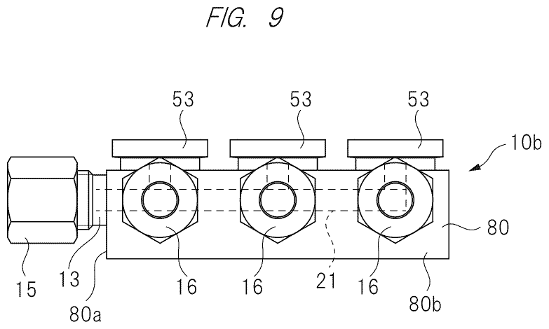

FIG. 9 is a front view showing a main body block in a manifold type control valve 10b. This main body block 80 has a rectangular parallelepiped shape, and a joint portion 13 in which a primary-side port is formed is provided so as to protrude to a front surface 80a of a main body block 80, and a nut 15 is attached to the joint portion 13. The primary-side flow path 21 communicating with the primary-side port of the joint portion 13 is formed in the main body block 80 in the longitudinal direction. Three joint portions (not shown) in each of which a secondary-side port is formed are provided so as to protrude from a side surface 80b of the main body block 80, and secondary-side flow paths that communicate with the secondary-side ports are formed in the respective joint portions. Further, a nut 16 is attached to each joint portion. Three flanges 53 are provided so as to protrude on the upper surface of the main body block 80, and the flange 56 of the cylinder 12 shown in FIG. 4 is abutted against each flange 53, and the valve member 25 is arranged between the main body block 80 and the three cylinders 12, respectively. Consequently, the manifold type control valve 10b, which includes the main body block 80 having the common primary-side flow path and the plurality of secondary-side flow paths, is configured. Note that the main body block 80 may include the plurality of primary-side flow paths and the common secondary-side flow path.

In this way, also in the manifold type control valve configured so that at least one of the number of primary-side flow paths and the number of secondary-side flow paths is plural and that the plurality of cylinders 12 are attached to the single main body block 80, the plurality of cylinders 12 can be attached to the main block body 80 by using the fixing pin 74. The manifold type control valve 10b including the plurality of miniaturized cylinders 12 is obtained.

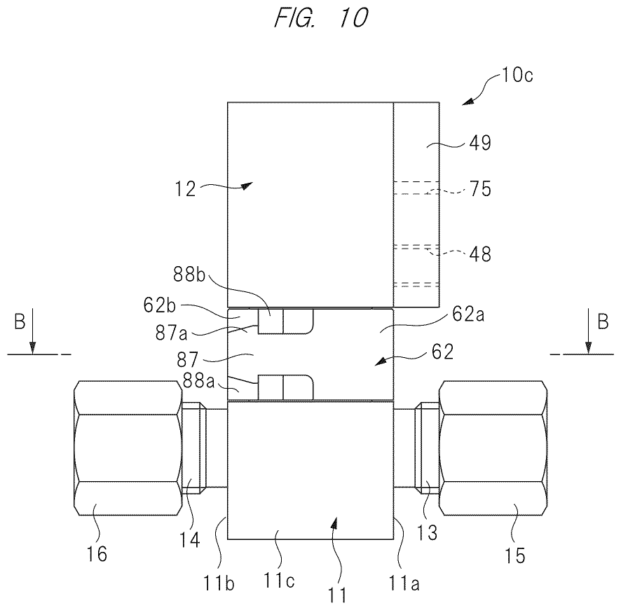

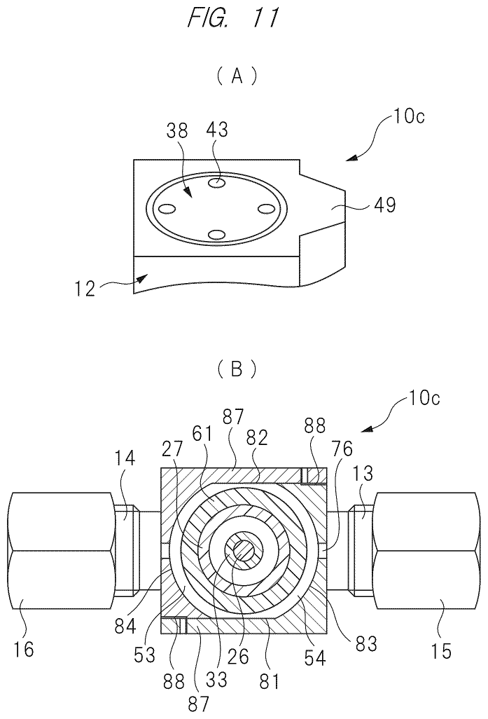

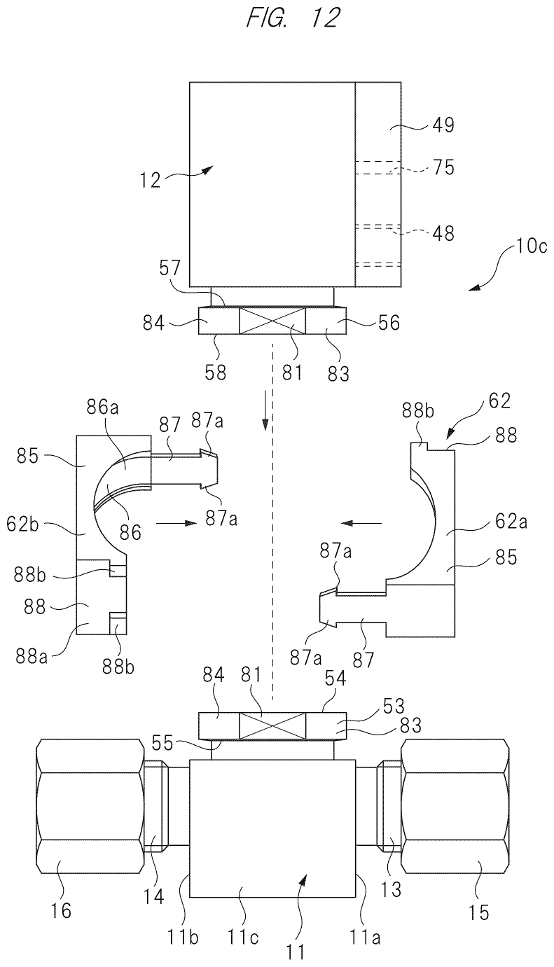

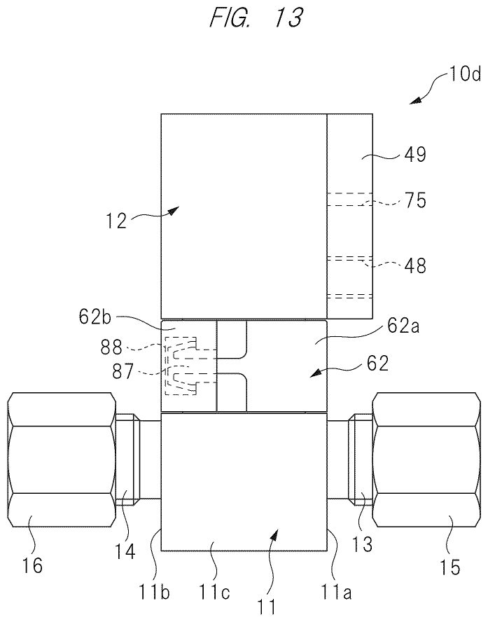

FIG. 10 is a front view of a control valve 10c, which is another embodiment. FIG. 11(A) is a perspective view showing an upper end portion of the cylinder of FIG. 10, and FIG. 11(B) is a cross-sectional view taken along the line B-B in FIG. 10. FIG. 12 is an exploded view of the control valve 10c. In these figures, the same reference numerals are given to members having common properties with the control valve 10c described above.

In the control valve 10c, the piston 32 incorporated in the cylinder 12, the flow path formed in the main body block 11, and the valve member 25 provided in the piston rod 33 are the same as those of the control valve 10a shown in FIG. 4. As shown in FIG. 10, the operation portion 49 extends to the upper end portion of the cylinder 12, and the breath hole 75 is opened to the operation portion 49 adjacent to the operation port 48. Note that similarly to the control valve 10c, the operation portion 49 in the control valve 10a may be provided so as to extend to the upper end surface of the cylinder 12.

In the control valve 10a described above, the fastening member 62 for fastening the main body block 11 and the cylinder 12 is a pin fixing type for fixing the main body block 11 and the cylinder 12 by the fixing pin 74, whereas in the control valve 10c, the fastening member 62 is formed by engaging and assembling the plurality of fastening adapters. Since the fixing pin 74 is not used, the attachment hole 71 is not formed on the upper end surface of the cylinder 12 as shown in FIG. 11(A).

The fastening member 62 shown in FIG. 12 is assembled by mutually combining the first fastening adapter 62a and the second fastening adapter 62b. FIG. 11(B) shows an abutment surface 54 of the flange 53 of the main body block 11, and the outer peripheral surface of the flange 53 is provided with flat surfaces 81, 82 in parallel with each other. The flat surface 81 is parallel to the side surface 11c of the main body block 11, and the flat surface 82 is parallel to a side surface 11d opposite to it. A length of the flat surfaces 81, 82 in a right-left direction in FIG. 11(B) is slightly longer than ⅓ of the diameter of the flange 53.

As shown in FIG. 12, a flat surface 81 is provided on the flange 56 of the cylinder 12 correspondingly to the flat surface 81 of the flange 53. Further, a similar flat surface is provided on the flange 56 of the cylinder 12 correspondingly to the flat surface 82 of the flange 53. When both flanges 53, 56 are abutted against each other, the flat surface 81 of the flange 53 and the flat surface 81 of the flange 56 are adjacent to each other. Similarly, the flat surface 82 of the flange 53 and the flat surface of the flange 56 are adjacent to each other.

The outer peripheral surfaces of the respective flanges 53, 56 have a convex-shaped arc surface 83 on a front surface side of the main body block 11 and a convex-shaped arc surface 84 on a back surface side. Circumferential lengths of the respective arc surfaces 83, 84 are the same. In FIG. 12, a part of each arc surface 83, 84 is shown. In this way, the outer peripheral surfaces of the flanges 53, 56 are configured from the two flat surfaces 81, 82 and the two arc surfaces 83, 84.

As shown in FIG. 12, both fastening adapters 62a, 62b have the same shape and have fastening pieces 85 for fastening the flanges 53, 56. A recessed groove 86 into which the flanges 53, 56 enter is provided in the fastening piece 85, and a bottom surface 86a of the recessed groove 86 opposes the arc surfaces 83, 84 of the flanges 53, 56. Engagement claw 87 is provided at one end portion of the fastening piece 85, and the engagement claw 87 extends in a right-angel direction with respect to the fastening piece 85. A groove-shaped engagement portion 88 is provided at the other end portion of the fastening piece 85. A protrusion 87a is provided at a tip of the engagement claw 87, and the engagement portion 88 is formed by a groove portion 88a into which a tip portion of the engagement claw 87 enters, and a meshing portion 88b with which the protrusion 87a meshes.

It is assumed that the engagement claw 87 of the first fastening adapter 62a is a first engagement claw, the engagement portion 88 is a first engagement portion, the engagement claw 87 of the second fastening adapter 62b is a second engagement claw, and the engagement portion 88 is a second engagement portion. When the first engagement claw 87 shown in FIG. 12 is engaged with the second engagement portion 88 and the second engagement claw 87 is engaged with the first engagement portion 88, the two fastening adapters 62a, 62b are combined with each other as shown in FIG. 11(B). The arc surface 83 enters into the recessed groove 86 of the first fastening adapter 62a, and the arc surface 84 enters into the recessed groove 86 of the second fastening adapter 62b. Further, the engagement claw 87 of the first fastening adapter 62a contacts with the flat surface 81, and the engagement claw 87 of the second fastening adapter 62b contacts with the flat surface 82. Consequently, the engagement type fastening member 62 composed of the two fastening adapters 62a, 62b is assembled, and the main body block 11 and the cylinder 12 are fastened.

As shown in FIG. 12, a fastening surface 55 composed of an inclined surface is formed on the flange 53, a fastening surface 57 composed of an inclined surface is formed on the flange 56, and similarly to the fastening adapters 62a, 62b shown in FIG. 4, the fastening force is applied to both the flanges 53, 56 by the fastening member 62.

Although the control valve 10c is formed by the two fastening adapters 62a, 62b, the fastening member 62 may be formed by three or more fastening adapters.

FIG. 13 is a front view showing a control valve 10d which is yet another embodiment. In the control valve 10d, a shape of the engagement portion 88 with which the tip portion of the engagement claw 87 is engaged is different from that of the control valve 10c. The engagement portion 88 is a bottomed hole for housing the engagement claw 87, and the engagement claw 87 is inserted from an insertion hole 88c. Consequently, an appearance of the control valve 10d is better than the control valve 10c. Further, when the engagement claw 87 is inserted from the insertion hole 88c and the tip portion of the engagement claw 87 enters into the groove portion 88a and the protrusion 87a meshes with the engagement portion 88b, the engagement claw 87 is engaged with the engagement portion 88. By doing so, since the engagement claw 87 cannot be operated from outside due to a bottomed-hole shape of the engagement portion 88, the engagement claw 87 can be prevented from coming off the engagement portion 88 due to an erroneous operation. The two fastening adapters 62a, 62b in the control valve 10d have the same shape.

As described above, the two fastening adapters 62a, 62b of the control valves 10c, 10d have the same shape. However, the engagement claw 87 is provided at both ends of the fastening piece of one fastening adapter, and the engagement portion 88 may be provided at both ends of the fastening piece of the other fastening adapter. However, in this case, since the shapes of the two fastening adapters are different, the number of components is increased. Therefore, as shown in FIGS. 12 and 13, if the two fastening adapters 62a, 62b have the same shape, assembly and component management of the fastening member 62 are facilitated. Further, when the fastening member 62 is used as an engagement assembly structure like the control valves 10c, 10d, the fixing pin 74 used in the control valve 10a described above becomes unnecessary.

The present invention is not limited to the above-described embodiment, and can be variously modified within a range not departing from the gist of the present invention. For example, the control valve illustrated is an on-off valve that communicates the primary-side flow path and the secondary-side flow path when the valve member 25 is at the first position, and cuts off the primary-side flow path and the secondary-side flow path when the valve member 25 is at the second position. As another control valve, by changing the opening degree of the valve element when the valve member 25 is at the first position and at the second position, the present invention can be applied also as a control valve for controlling the flow rate and the pressure of the fluid flowing into the secondary-side flow path from the primary-side flow path and as a suck-back valve for changing the volume of the communication chamber 29 together with the communication opening by vertically moving the valve member 25. A difference between the on-off valve and those control valves is that the primary-side flow path and the secondary-side flow path are a state of communicating with each other even when the valve member 25 is at the second position. Further, although the valve member 25 is a diaphragm valve, a poppet type valve member may be provided on the piston rod 33. In addition, the main body block 80 may have a plurality of flanges 53, or may have both a plurality of primary-side flow paths and a plurality of secondary-side flow paths, or one of the primary-side flow path and the secondary-side flow path one by one.

This control valve is mounted on a fluid supply device for supplying a fluid from a fluid pressure source to a fluid pressure operation device, and is used to open/close a flow path for guiding the fluid to the fluid pressure operation device or to control the pressure.

While the present disclosure has been illustrated and described with respect to a particular embodiment thereof, it should be appreciated by those of ordinary skill in the art that various modifications to this disclosure may be made without departing from the spirit and scope of the present disclosure.

1. A control valve comprising:
a main body block forming a primary-side flow path to which a fluid is supplied and a secondary-side flow path discharging the fluid;
a cylinder attached to the main body block, and incorporating a valve drive mechanism;
a communication portion communicating the primary-side flow path and the secondary-side flow path;
a valve member arranged between the main body block and the cylinder, and changing a communication opening degree of the communication portion by the valve drive mechanism;
a fastening member sandwiching a first flange provided in the main body block and a second flange provided in the cylinder, and fastening the main body block and the cylinder; and
a fixing pin communicating with a communication hole formed in the fastening member, and press-fitted into an attachment hole, which is formed in the cylinder, and the communication hole.

2. The control valve according to claim 1,
wherein an end surface of the cylinder is a polygon, and the attachment hole is formed at a corner portion of the cylinder.

3. The control valve according to claim 1,
wherein the fastening member has at least two fastening adapters, and the fastening adapters have at least two communication holes.

4. The control valve according to claim 1,
wherein an end surface of the cylinder is a quadrangle, and the attachment hole is formed at four corners of the cylinder, and
the fastening member has a first fastening adapter in which two communication holes adjacent to each other are formed along a same outer surface, and a second fastening adapter in which two other communication holes are formed.

5. A control valve comprising:
a main body block forming a primary-side flow path to which a fluid is supplied and a secondary-side flow path discharging the fluid;
a cylinder attached to the main body block, and incorporating a valve drive mechanism;
a communication portion communicating the primary-side flow path and the secondary-side flow path;
a valve member arranged between the main body block and the cylinder, and changing a communication opening degree of the communication portion by the valve drive mechanism, and;
a fastening member sandwiching a first flange provided in the main body block and a second flange provided in the cylinder and fastening the main body block and the cylinder,
wherein the fastening member has a plurality of fastening adapters combined with each other by engagement between an engagement claw and an engagement portion with which the engagement claw is engaged.

6. The control valve according to claim 5,
wherein the fastening member has a first fastening adapter and a second fastening adapter,
the first fastening adapter has a first engagement portion and a first engagement claw, and
the second fastening adapter has a second engagement claw with which the first engagement portion is engaged, and a second engagement portion with which the first engagement claw is engaged.

7. The control valve according to claim 5,
wherein a flat surface is provided on each of an outer peripheral surface of the first flange and an outer peripheral surface of the second flange, and each of the engagement claws corresponds to each of the flat surfaces.

8. The control valve according to claim 1,
wherein the fastening member has: a first pressing portion provided with an inclined surface for pressing an inclined surface of the first flange; and a second pressing portion provided with an inclined surface for pressing an inclined surface of the second flange, and
when the fastening member sandwiches the first flange and the second flange, a fastening force in a direction of approaching the first flange and the second flange is applied.

9. The control valve according to claim 1,
wherein the cylinder has a cylinder hole to which a piston is movably attached,
the valve member is a diaphragm valve having: an annular portion sandwiched between the main body block and the cylinder; a valve body attached to the piston rod of the piston and opening/closing the communication portion; and an elastic deformation portion between the annular portion and the valve body.

10. The control valve according to claim 1,
wherein the main body block is formed into a manifold shape having: a plurality of at least one of the primary-side flow path and the secondary-side flow path; and a plurality of cylinders, respectively attached to a plurality of first flanges provided in the main body block, the plurality of cylinders being configured by the cylinder, and the plurality of first flanges being configured by the first flange.

11. The control valve according to claim 10,
wherein the main body block has a plurality of at least one of the primary-side flow path and the secondary-side flow path.

12. The control valve according to claim 1,
wherein the valve member changes the communication opening degree of the valve seat portion at a position of opening the communication portion and at a position of closing the communication portion.
